(19) United States
(12) Patent Application Publication
(10) Pub. No.: US 2014/0312747 A1
(43) Pub. Date: Oct. 23, 2014

(54) PRODUCT VENDING ENCLOSURE AND DOOR RETROFIT

(71) Applicant: Fastcorp 2, LLC, Shawnee Mission, KS (US)

(72) Inventors: Fernando A. Ubidia, Ludlow, MA (US); Aaron Stein, Middletown, CT (US)

(73) Assignee: Fastcorp 2, LLC, Shawnee Mission, KS (US)

(21) Appl. No.: 14/260,236

(22) Filed: Apr. 23, 2014

Related U.S. Application Data
(60) Provisional application No. 61/815,159, filed on Apr. 23, 2013.

(51) Int. Cl. G07F 9/10

(52) U.S. Cl. CPC G07F 9/10
USPC 312/35; 312/326; 156/196

(57) ABSTRACT

The present invention generally pertains to an enclosure constructed from homopolymer and/or copolymer thermal plastic, preferably polypropylene members and a method of construction therefore. Particularly, such enclosures are utilized in the construction of vending machines, product dispensing machines and the like. The polymer members used for the enclosure material are at least partially formed from homopolymer material, or copolymer material, or a combination of homopolymer and copolymer materials.

### CROSS-REFERENCE TO RELATED APPLICATION

This application claims priority to U.S. Provisional Application Ser. No. 61/815,159 filed Apr. 23, 2013, the entirety of which is incorporated herein by this reference.

### FIELD OF THE INVENTION

The present invention relates generally to an exterior enclosure of a product vending machine as well as a method of construction of such exterior enclosures. The enclosure is constructed of a polymer material. The polymer material is either homopolymer, copolymer, or a combination of homopolymer and copolymer. The polymer material in some embodiments is a thermoplastic such as polypropylene.

Generally, the construction of an enclosure is achieved by cutting, bending, and/or welding one or more sheets of polymer material into a desired shape of a product vending machine. Various additionally polymer or non-polymer segments in some embodiments are coupled to the overall cabinet structure to create shelves and/or supports for various internal vending machine components such as refrigeration units, a user interface, product holding devices or electromechanical components and the like. The various product vending components in some embodiments are also secured directly to the polymer enclosure, shelves and/or support segments.

### BACKGROUND OF THE INVENTION

Typical vending machine enclosures for vending and dispensing equipment are constructed using sheet metal to form the enclosures. Various sheet metal members are mechanically fastened together and/or welded using traditional metal welding techniques so as to provide the structure necessary for maintaining products in a controlled environment and to prevent theft of products. In order to produce the sheet metal members economically, large and costly capital equipment is required such as turret presses, shears, and press breaks.

Maintaining and servicing traditional vending machines can also pose problems. For instance, many traditional vending machines no longer meet the current Americans with Disabilities Act (“ADA”) regulations. Consequently, when a machine is taken out of service for repair, it may need to be updated to meet the new ADA regulations prior to being redeployed. Furthermore a vending machine manufacturer may need to fulfill the wants of new customers and to update the aesthetics and features of an older vending machine in accordance with current trends, such as adding touch screens and large format display screens.

In traditional machines, the doors are the most problematic. For instance, they contain the user interface portion of the machine which is generally the feature of the machine that does not comply with the ADA. Additionally, retrofitting old machines with new doors manufactured according to traditional techniques is particularly expensive, at least in part, because the new door must essentially be made from scratch while the old door is discarded. The reason is that the placement of the user interface components in the new door disrupts the various holes, welds, reinforcements and security features of the traditional doors so extensively that the structure of the old door, which is typically constructed using sheet metal to form both the door and the security features of the machine, would be compromised through a retrofit. Thus, it is difficult and costly to update old machines.

Traditional metal materials used for enclosures, usually steel and sometimes aluminum, are very strong. However, they are also relatively heavy materials, and therefore the material thickness of the enclosure members is limited for practical use concerning enclosure weight (as well as material cost). It is not uncommon for vending machine enclosures to be six feet in height and several feet wide and deep. For enclosures of this size, the thickness of the sheet metal members is necessarily made thin, and despite the material strength of metals, the thin material sections are structurally weak. This is often times mitigated by welding or fastening additional metal members to add strength. However, this adds to the overall cost of the enclosure.

In construction, multiple thin enclosure members are welded and/or fastened together to achieve the strength required for the enclosure. The process of metal welding requires the welder to undergo extensive training and poses a very high skill level to properly execute the technique. The mechanical fastening process requires additional parts such as screws, rivets, etc. which add to the cost of the enclosure and typically do not create as strong a joint as welding. Also, utilizing metal as the primary structural component adds significant weight to the overall vending machine. Metal enclosures further require additional painting or plastic covers in order to make them aesthetically attractive to customers as well as to prevent oxidation and corrosion.

For practical applications, sheet metal enclosures are restricted in their shape to square or angular geometry. This is due to a number of factors: the equipment and processes for creating complex geometry or surface contours on large sheet metal members is often cost prohibitive; the process for joining complexly contoured sheet metal shapes is difficult; and the minimal thickness of the sheet metal members does not allow for any substantial edge finishing or embellishment (bevels, radii, high relief engraved designs etc.). The manufacturing process for production volumes of sheet metal enclosures requires several sets of permanent tooling to produce the geometric features of the enclosure, features such as holes, slots, bends etc., in a cost effective manner. Therefore, design changes for sheet metal enclosures are costly, requiring modification to the permanent tooling, or the creation of new tools altogether.

### SUMMARY OF THE INVENTION

The present invention solves the foregoing problems through the utilization of a unique structural material as well as a unique method of manufacture in the production of product vending machines. The present invention generally pertains to an enclosure constructed, at least in part, from polymer members and a method of construction therefore. Particularly, some embodiments of such enclosures are utilized in the construction of vending machines, product dispensing machines and the like. In certain embodiments, the polymer members used for the enclosure material are comprised entirely of homopolymer polypropylene or entirely of copolymer polypropylene. Alternatively, in some embodiments a combination of homopolymer and copolymer polypropylene members is used.

Embodiments of the present invention provide for the polymer members utilized in the manufacture of the enclosure to be joined by hot gas (typically air or nitrogen) welding or extrusion welding. In the joining process, the polymer members are, in some embodiments, welded together to form a unitary, structure without the utilization of fasteners or brackets. The construction of the enclosure also reduces the appearance of welding beads which are typically found when two or more sections of metal are joined together, because the welding joints created in the construction of the vending machine cabinets are capable of being substantially ground down and smoothed to reduce their profile.

Alternately, in some embodiments, heat bending of a single flat polymer sheet is utilized to create the multiple facets of an enclosure. In creating an enclosure utilizing a single sheet of material, it is preferable in some embodiments that a groove is cut into the material at the bending location. The groove facilitates the bending of the material at the proper location and allows for a tight bend radius by minimizing the material displaced at the inside joint of the bend. Heated bending also eliminates the need for additional welding as the heated material on the inside of the bend fuses together upon completion of the heated bending process.

The utilization of polymer sheets in forming the enclosure structure also allows the structure to be formed into curves and other contoured shapes so that in some embodiments, complex geometry are capable of being added to the enclosure. The polymer enclosures naturally have strong resistance to weathering and chemicals, and they require no paint or coatings to protect their surface. Furthermore, embodiments provide for additional polymer members to be welded to the enclosure walls to create I-sections, T-sections, and/or U-sections to increase the structural strength and rigidity of the enclosure in high load bearing areas. Additional shelving and support elements are also included in other embodiments. Thus while the overall structure of the cabinet is capable of being reinforced with a variety of other materials, it need not be because at least some of the embodiments of the present invention provide for the overall structural integrity of the enclosure to be reliant on the polymer material alone.

Utilizing polymer material as a structural enclosure also provides for construction techniques and parameters that are simpler and more economical than those of traditional sheet metal enclosures. For instance, the quantity and cost of the equipment required to manufacture the polymer enclosures, such as CNC routers and bending bars, is less than that required in the construction of metal enclosures. And while welding and heated bending of polymer material requires training to properly execute, the welding and bending operations do not require the same high degree of skill that is required for welding metal. Consequently, labor costs associated with producing polymer enclosures is less than labor costs associated with producing metal enclosures.

Embodiments of many of the polymer enclosure walls are capable of being formed using heated bending of a single sheet, which reduces the number of separate parts needed for the enclosure. Reducing the number of parts also eliminates the need for fasteners, thereby further reducing the overall number of parts required for the enclosure. Additionally, polymer sheets are capable of being cut much easier and without specialized equipment than metals, which further reduces the manufacturing cost of the enclosure members.

Polymers are typically very light in comparison to metals. For instance, polypropylene has approximately 1/10th the density of steel and approximately ⅓rd the density of aluminum. Consequently, polypropylene enclosures are capable of being produced with much greater material thickness than sheet metal enclosures and yet still have comparable weight as that of a sheet metal enclosure of the same size. Additionally, the mechanical strength of the polypropylene enclosure is equivalent to and often greater than that of a sheet metal enclosure.

Polymer enclosures also reduce maintenance costs. For example, impact to the wall of a sheet metal enclosure, possibly from being tipped over, kicked or hit, will result in denting and marring the enclosure. In such instances, it is impractical to repair the damage to the metal due to the relative difficulty of working with sheet metal. Particularly, a repair will generally require cutting, welding and grinding of the sheet metal, followed by painting to repair a damaged metal enclosure. Conversely, embodiments of the present invention provide for a similarly damaged polymer enclosure to be readily repaired. The damaged section of the enclosure is capable of being cut away and a new section of polymer material is shaped and welded in place. Furthermore, because polymer is much more impact resistant than sheet metal, a polymer enclosure may not require any repair at all.

The polymer enclosure is particularly suitable to complex surface contours. For instance, the polymer members are capable of being formed into complex shapes using heat forming. These shaped members are then capable of being easily welded to the enclosure structure using the welding methods of the present invention. Additionally, because the polymer members are capable of being practically manufactured with a substantial thickness, and because it is efficiently machined, embodiments of the present invention provide for bevels and radii and other, more complex edge finishes to be added to the enclosure, and complex geometry to be cut into the enclosure walls themselves. This gives the polymer enclosure a greater number of both functional and aesthetic design options while maintaining a cost effective design.

The manufacturing process for the polymer enclosure members also requires little to no permanent tooling. Instead, the members are capable of being efficiently manufactured on CNC cutting equipment. Consequently, if design changes are needed, a relatively inexpensive programming change—rather than a costly tooling change—is all that is required.

Another advantage that the thick walls of the polymer enclosure provides is the capability to effectively mount the internals of the vending and dispensing equipment (robotics, electronics, currency handling devices, etc.) directly to the walls by using self-threading fasteners. Due to the thin material thickness of sheet metal members, sheet metal screws, which are prone to stripping, are often used. Other times, threaded inserts—which add cost to the equipment—are required to adequately fasten the internal devices. The polymer enclosure does not require threaded inserts, and provides a cost effective means to securely mount the internal devices.

In one embodiment of the present invention, the manufacture of the enclosure according to the methods described above focuses on the manufacture of the door of the enclosure. Accordingly, a newly manufactured polymer door may be manufactured to replace traditional doors that do not comply with the ADA. In some embodiments the polymer door is also equipped with a number of integrated features that simplify the assembly of the machine by eliminating discrete component parts. Utilizing the techniques described, a new polymer door can be easily manufactured and then affixed to an old vending machine.

In a further embodiment of the present invention, an attachment mechanism is included that is particularly designed for the retrofit attachment of the polymer door to a traditional metal vending machine. The attachment mechanism simplifies the structure of the machine and eliminates parts otherwise necessary when manufacturing and attaching traditional metal door.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### DRAWINGS

FIG. 1 is an exploded view of a product vending enclosure.

FIG. 2 is a perspective view of one embodiment of the product vending enclosure including various internal components.

FIG. 3 is an exploded view of one embodiment of an exterior cabinet of a product vending enclosure.

FIG. 4 is a perspective view of one embodiment of an exterior cabinet of a product vending enclosure.

FIG. 5A is a plan view of two pieces of polymer material welded together.

FIG. 5B is a cross sectional view as taken along the line A-A of FIG. 5A.

FIG. 6A is a plan view of two perpendicular pieces of polymer material welded together.

FIG. 6B is a cross sectional view as taken along the line B-B of FIG. 6A.

FIG. 7A is a plan view of a piece of polymer material that has been heated and bent to form a perpendicular corner welded at the bending site.

FIG. 7B is a cross sectional view as taken along the line C-C of FIG. 7A.

FIG. 8 is a depiction of an example of a screw fastener engaged in a section of polymer material.

FIG. 9 is a depiction of another example of a screw fastener engaged in a section of polymer material.

FIG. 10 is a perspective view of an embodiment of an enclosure including a door secured by a securing mechanism.

FIG. 11 is a perspective view of another embodiment of an enclosure including a door secured by a securing mechanism.

FIG. 12 is a perspective view of an embodiment of an enclosure having a door that pivots about an axis.

FIG. 13 is an exploded view of an embodiment of a door.

FIG. 14 is a perspective view of a door.

FIG. 15 is a perspective view of an embodiment of a product vending enclosure

FIG. 16A is a perspective view of a panel of material having grooves along bending sites.

FIG. 16B is a perspective view of a panel that has been bent along grooved bending sites to form a “U” shape.

FIG. 17 is a perspective view of an embodiment of a vending enclosure including various shelves and structural supports.

FIG. 18 is a perspective view of an embodiment of an exterior cabinet utilizing an L-shaped support structure.

FIG. 19 is an exploded view of an embodiment of an exterior cabinet utilizing an L-shaped support structure as in FIG. 18.

FIG. 20 is a perspective view of an embodiment of a cabinet utilizing an additional support strut.

FIG. 21 is an isolated view on an enlarged scale taken from FIG. 20.

FIG. 22 is a sectional view of an embodiment of a cabinet utilizing an additional support strut taken from FIG. 20.

FIG. 23 is a perspective view showing an attachment mechanism attaching a door to a traditional metal cabinet.

FIG. 24 is a sectional view of an attachment mechanism attaching a door to a traditional metal cabinet taken from FIG. 23.

FIG. 25 is a sectional view of an attachment mechanism attaching a door to a traditional metal cabinet taken from FIG. 23.

FIG. 26 is a perspective view of an embodiment of a cabinet and door including a door roller support and ramp.

FIG. 27 is a partial view of an embodiment of a cabinet showing studs utilized in the manufacture of the cabinet.

FIG. 28 is a section view showing studs utilized in the manufacture of a cabinet.

FIG. 29 is a perspective view of a door showing a structurally integrated product chute.

FIG. 30 is a perspective view of a door showing a reinforced security column.

FIG. 31 is a perspective of the reinforced security column shown in FIG. 30.

### DETAILED DESCRIPTION OF THE PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In embodiments of the present invention, a polymer material is utilized to create an enclosure of a vending machine. The polymer material is either a homopolymer, a copolymer, or a combination of homopolymer and copolymer. In one embodiment, polypropylene is utilized. It is also preferable that a homopolymer is utilized to create the exterior of the vending machine as its utilization results in a more aesthetically pleasing surface finish, it withstands higher temperatures, and it is more rigid than a copolymer.

A first method of constructing the enclosure begins with multiple sheets of polymer material. In some embodiments, the sheets are precast into particular desired shapes. In alternative embodiments, at least one sheet is cut from a larger sheet. In still other alternative embodiments, at least one sheet is formed into a desired shape.

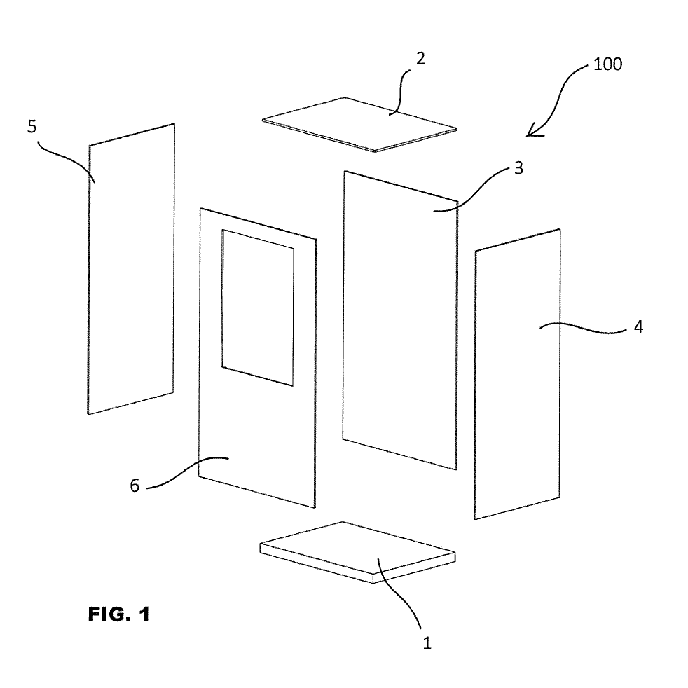

In one embodiment of the present invention, an enclosure 100 begins with six sheets or panels of material, a bottom 1, a top 2, a back 3, two sides 4, 5 and a front 6. (FIG. 1). In some embodiments, the front 6 comprises a door 200.

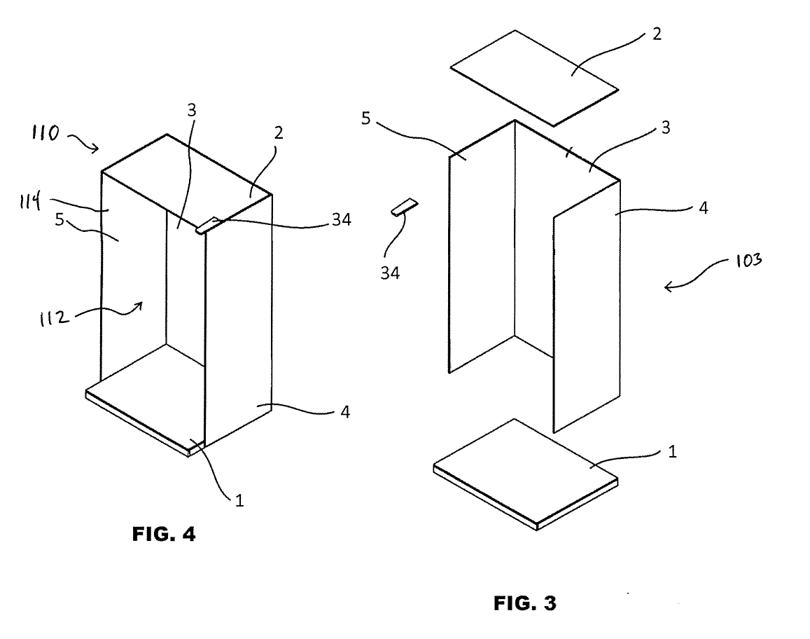

In another embodiment of the present invention, a first sheet of polymer material is cut to create a bottom panel 1, a second sheet of polymer material is cut to create a top panel 2, and a third sheet of polymer material is cut and formed to create a U-shaped piece 103. (FIG. 3). The bottom panel 1, the top panel 2, and the U-shaped piece 103 are coupled together to create an exterior cabinet 110 that defines an interior area 112. (FIG. 4).

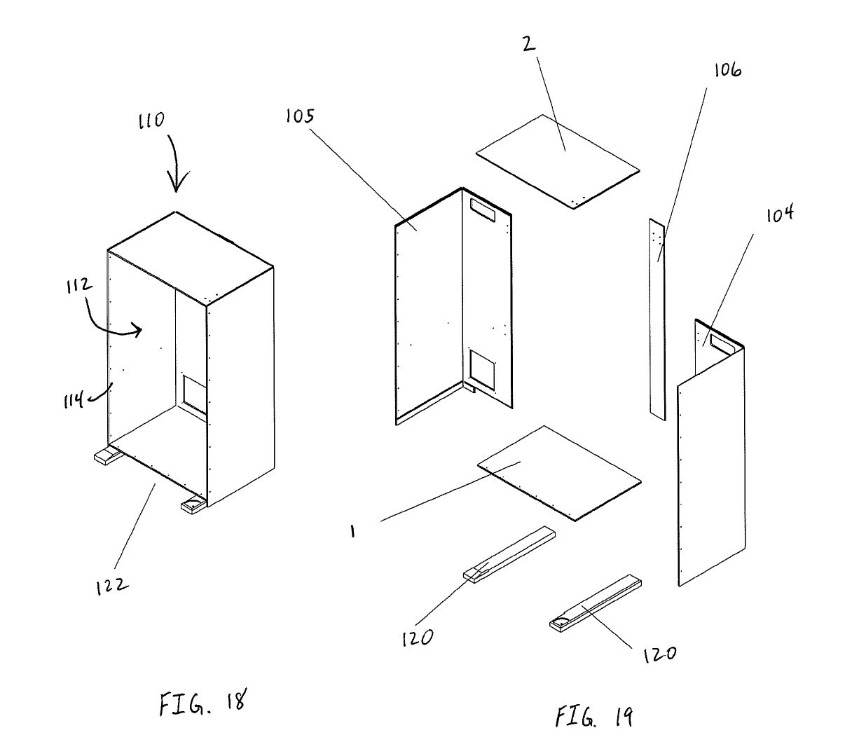

In yet another embodiment of the present invention, a first sheet of polymer material is cut to create a bottom panel 1, a second sheet is cut to create a top panel 2, a third sheet of polymer material is cut and formed to create a first L-shaped piece 104, and a fourth sheet of polymer material is cut and formed to create a second L-shaped piece 105. (FIG. 19). The bottom panel 1, the top panel 2, and the first and second L-shaped pieces 104, 105 are coupled together to create an exterior cabinet 110 that defines an interior area 112. (FIG. 18).

In one embodiment, the door 200 is coupled to the exterior cabinet 110 and is movable between a closed position and an open position. In the open position, the door 200 allows access to the interior area 112 of the exterior cabinet 110. In the closed position, the door 200 inhibits access to the interior area 112 of the exterior cabinet 110. In one embodiment, the door 200 is hingedly coupled to the exterior cabinet 110 at a hinge side 204 of the door and includes a latch member 210 that couples a latch side 205 of the door to the exterior cabinet 110 when the door 200 is in the closed position.

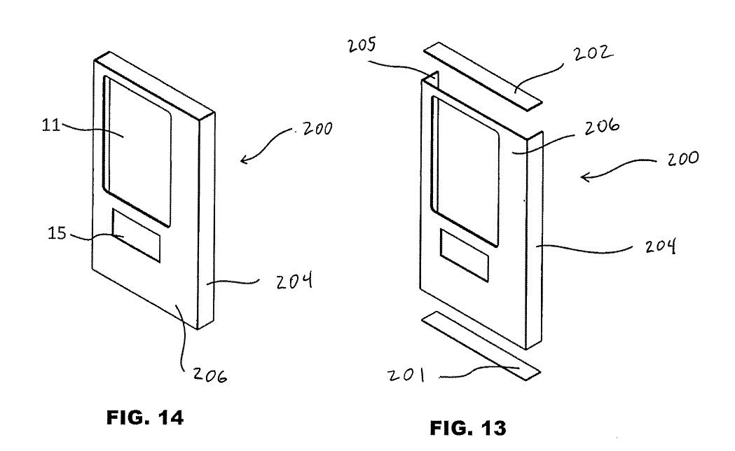

In one embodiment, the door 200 is fabricated using multiple sheets of polymer material. A first sheet of polymer material is cut to create a bottom plate 201, a second sheet of polymer material is cut to create a top plate 202, and a third sheet of polymer material is cut and formed to create a front panel 206. (FIG. 13). The bottom plate 201, the top plate 202, and the front panel 206 are coupled together to create the door 200. (FIG. 14).

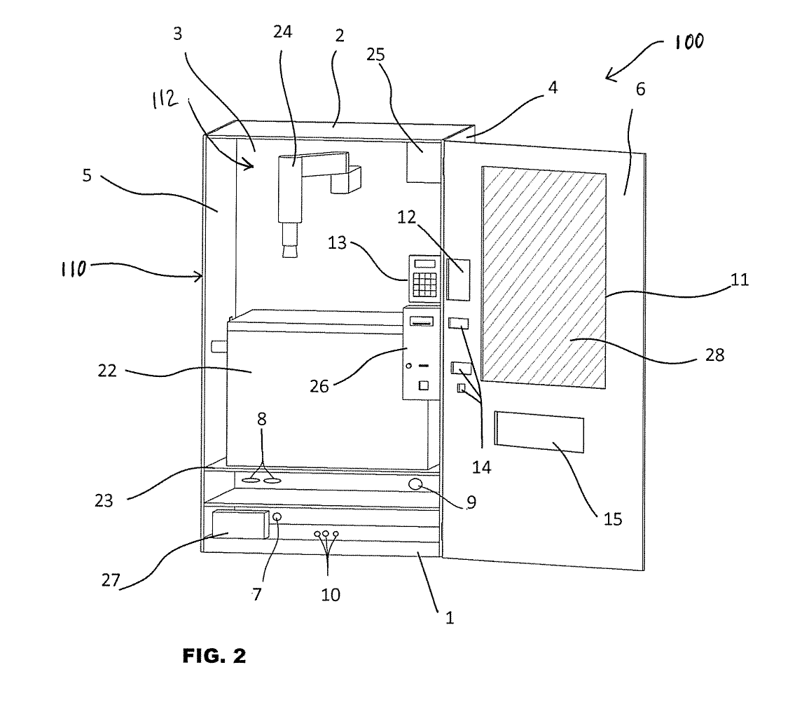

FIG. 2 is an example of an embodiment of a front opening vending machine enclosure. Creating a font-opening vending machine begins by forming necessary openings in the various sheets. For example, in certain embodiments, the back 3 includes a hole 7 cut for a power cord or venting holes 8 and a hole 9 for a fluid pipe. Similarly, the bottom 1 includes holes 10 for venting or drainage. In some embodiments, the front sheet 6 includes a viewing window 11, a hole 12 for a user interface 13, slots 14 for monetary transactions, and a product dispensing hole 15.

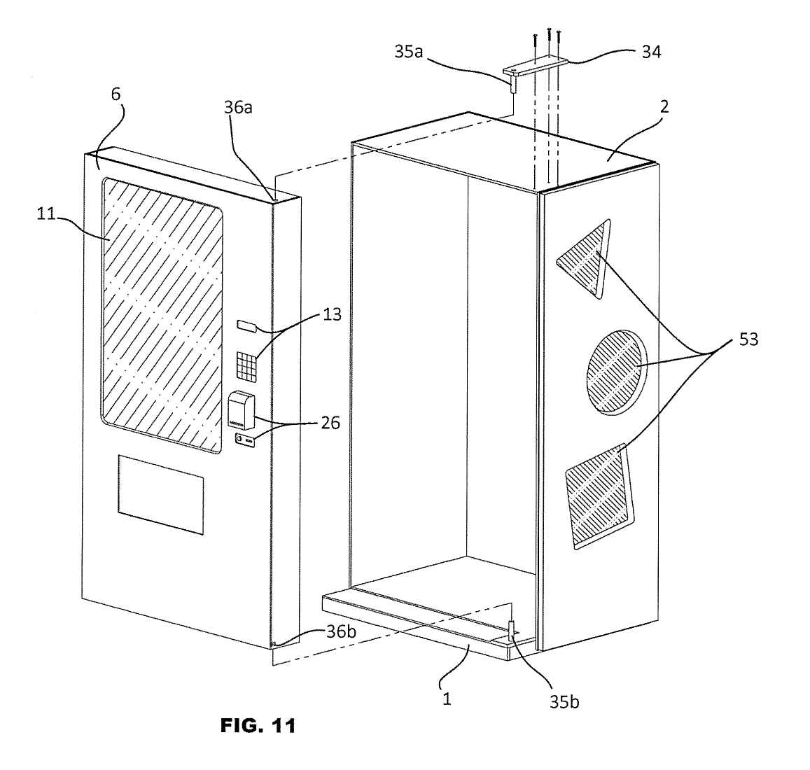

Embodiments of the present invention provide for the various holes to be cut and/or shaped using a router in order to impart a smooth or decorative finish. Other embodiments provide for the various sheets to also be engraved with various designs 53 (see FIG. 11), for example, a design signifying the product to be sold. Preferably in some embodiments, the various holes, slots, openings and designs are cut using a CNC router. Such routers are easily programmable and therefore creating the desired cuts only requires entering a particular program into the router.

Embodiments of the present invention also provide for various sheets of material to be bent or shaped. For example, certain embodiments provide for the front panel 206 of the door 200 to be rounded or curved to provide an added geometric element to the vending machine.

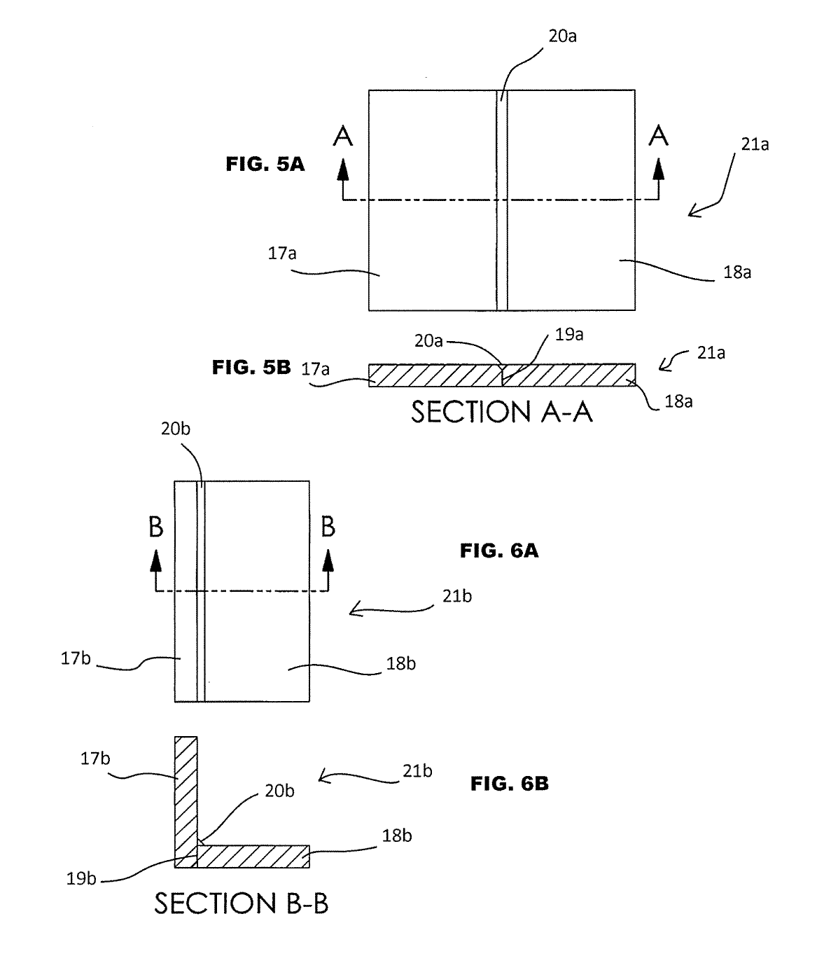

Embodiments of the present invention provide for each of the polymer members to be welded together. In some embodiments, welding the polymer members is generally accomplished by hot gas and/or extrusion welding. As such, two polymer members are joined by heating and melting a quantity of material of the same like and kind as the panels to be welded. For instance, in some embodiments a polymer rod having a length approximately equal to that of the desired weld is heated using a heat gun. The quantity of melted material is applied to the desired weld joint and allowed to cool, thereby joining the two panels. As shown in FIGS. 5A-5B, two panels of material 17a, 18a are abutted together at joint 19a. A rod of material 20a is laid along the joint 19a between panels 17a and 18a to join the panels together and form a single larger panel 21a. Alternately, in other embodiments, a corner is capable of being formed. In FIGS. 6A-6B, two panels of material 17b, 18b are abutted together at joint 19b. A rod of material 20b is laid along the interior of joint 19b to join panels 17b and 18b together to form a corner 21b. In certain embodiments, the weld joints are then smoothed and polished. Embodiments provide for the process to be repeated so as to form the desired shape, such as an open box, of the vending machine.

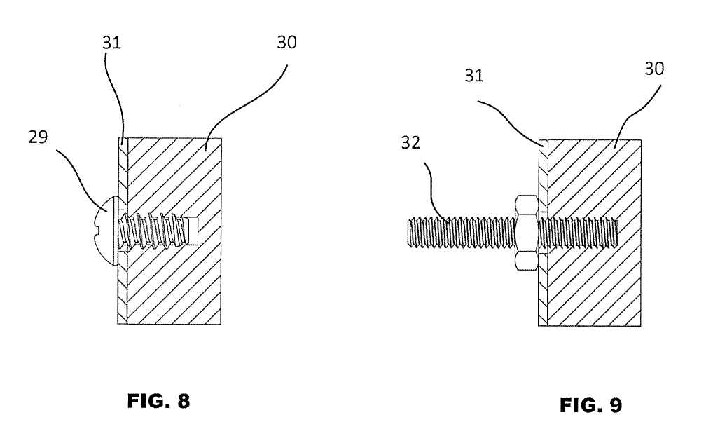

FIG. 2 depicts one configuration of an interior for the product vending enclosure. Upon completing the exterior cabinet 110, components of the vending machine are connected to the exterior cabinet 110. For example, embodiments provide for a product dispensing machine to include a refrigerant portion 22, product support structures such as a shelf or rack 23, electro mechanical mechanisms 24 to release a product, a controller 25 for controlling the electro mechanical mechanisms, a transaction segment 26, a user interface 13, and a power supply 27 secured within the interior area 112 of the exterior cabinet 110. It should be understood that the power supply need not create power, but instead simply transfer power from an external source, such as from a wall socket, to the interior powered components of the product vending machine. In some embodiments, a sheet of clear material 28, such as a transparent glass or Plexiglas is secured to the front panel 6 to create a viewing window 11. Preferably, self tapping screws are used to secure the various components to the panels. The polymer material is preferably of a relatively thick gauge. Preferably the material is in the range of 0.25 to 0.50 inches thick where primary load bearing members, such as the base, utilize material having a thickness of 0.375 inches and secondary load bearing members, such as the sides and back utilize material having a thickness of 0.25 inches. The thick gauge also allows for screws to be bored directly into the material. Thus, as shown in FIGS. 8 and 9, screws 29, 32 are provided with sufficient bite to engage the polymer panel 30 and securely fasten various components, such as component 31. Such construction allows the vending machine components to be securely fastened within the enclosure 100 without the use of additional fastening braces.

While embodiments of the present invention provide for other fasteners than screws to be used, the preferred screw fasteners provide some additional benefits. As shown in FIGS. 8 and 9, due to the relatively thick gauge, the screws 29, 32 are secured without fully penetrating the panel 30. That allows the vending components to be adequately secured within the enclosure without marring the external sides of the panels. Without any external damage, as is generally caused by using bolts and rivets that fully penetrate traditional sheet metal enclosures, there is no additional cover up work to be done in order to make the exterior of the enclosure aesthetically pleasing. It also prevents any engraved design present on the exterior of the panels from being damaged.

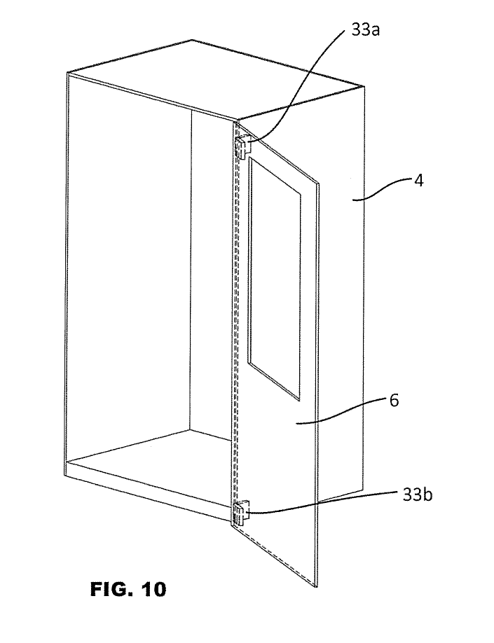

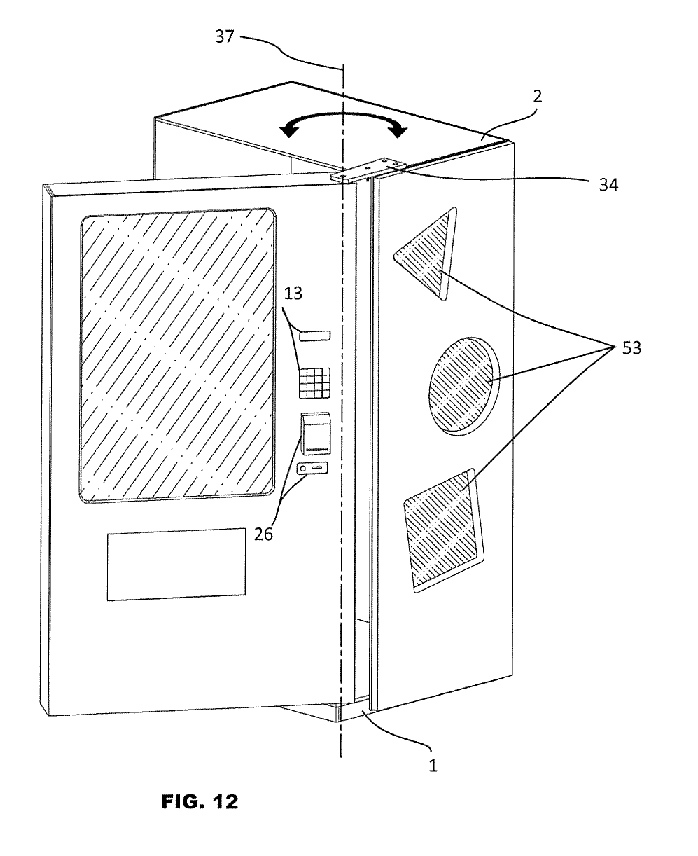

In certain embodiments, upon securing the various vending machine components in the interior area 112 of the external cabinet 110, the front panel 6, such as a door 200, is added to finish the enclosure 200 as shown in, for example FIG. 2. In some embodiments, the addition of the front panel is accomplished by affixing one or more securing mechanisms, such as hinges, to the external cabinet 110 and to the front panel 6. For example, as shown in FIG. 10, where the front panel 6 is depicted as transparent for the proposes of explanation, traditional door hinges 33a, 33b are screwed into a side panel 4 and are also screwed into the front panel 6 so as to permit the front panel to move between an open position and a closed position. Alternately, FIGS. 11-12 depicts another embodiment where one hinge having a fastening plate 34 and rod or pin 35a are affixed to the top panel 2 and another rod or pin 35b are affixed to the bottom panel 1. In some embodiments, the rod or pin elements are inserted into a top hole 36a and a bottom hole 36b in the front panel 6 so as to allow the font panel to swivel on an axis 37 created by the rods or pins of the hinge. Embodiments provide for various other types of hinges to be used. While hinges are preferred, in other embodiments, other well-known securing mechanisms, such as clips, clasps, locks and the like are utilized. Securing the front panel 6 to the exterior cabinet 110 completes the enclosure 100.

In the event that a part of the enclosure 100 is damaged, either during construction or once the enclosure 100 is placed in the field, embodiments of the present invention provide for the damaged enclosure to be easily repaired. In certain embodiments, to repair a damaged panel, the damaged section is cut away from the overall enclosure. A new, replacement panel (or panels) is cut from sheets of polymer material to fit the section that was cut away. In some embodiments, a CNC router is programed to cut or carve the necessary replacement holes, slots, openings or engraving designs into the replacement panel, so as to mimic those design elements removed along with the damaged section. Embodiments then provide for the replacement section to then be welded to the enclosure panels in the proper orientation. Thus, the damaged section is removed, and a replacement section added in a relatively seamless manner, virtually eliminating the evidence of the damaged section. The enclosure is then operable to be placed back into service in the field with little to no aesthetically off-putting signs of damage, without the need to scrap, salvage and rebuild a new enclosure, and without the need to employ highly skilled labor.

Alternately, in some embodiments, a heat bending process, preferably in combination with the hot gas or extrusion welding process, is utilized to construct the enclosure. The heat bending process begins with a sheet of polymer material that is formed or cut into a geometric shape that, when bent properly, forms appropriately sized and proportioned elements of the enclosure. Using a traditional rectangular box style enclosure as an example, the process begins with a large rectangular shape.

Similar to the construction utilizing multiple panels, in some embodiments, the single sheet of polymer is further cut to provide holes, slots, vents, other openings or engraved designs. Preferably, a CNC router is programed so as to perform the proper cutting/routing in the single sheet of material. Once the necessary holes and designs have been formed, embodiments provide for the material to be bent into the proper shape. In certain embodiments to bend the sheet without damaging or breaking it, heat bars are used to heat the material along a bend line. A heat bar is an elongated bar that is capable of being heated to a temperature sufficient to soften the polymer material when the heat bar is placed in close proximity to or placed directly against the polymer material. Such heat bars are known devices. Preferably the heat bars are raised to a temperature of between 500 and 600 degrees Fahrenheit depending on the specific homopolymer or copolymer material to be bent. The heat bars are applied to the polymer material so as to soften it in preparation for bending.

Once softened, preferably to the point where the material has melted, embodiments provide for the polymer material to be bent to the desired shape. For example, in certain embodiments heat bars are applied along junction lines that form the joints between the back 3 and sides 4, 5 of the enclosure 100. The sides 4, 5 are then bent such that they each come perpendicular to the back 3 to form an open “U” shape. The top 2 and bottom 1 are then welded to the open “U” shape to form an open box. The connection points between the sides 4, 5 and back 3 are thus concealed on the inside of the enclosure 100 and the only hot gas or extrusion welds is on the top and bottom of the enclosure. It is preferable that the back 3 and sides 4, 5 of the vending machine are formed by heated bending such that the bending weld is formed on the interior of the cabinet while the top 2 and bottom 1 are welded onto the back 3 and sides 4, 5 utilizing hot gas and/or extrusion welding. Formation of the cabinet according to the forgoing reduces the use of visible welds, regulating the visible welds to the very top and very bottom of the machine where they are unlikely to be observed by a vending machine customer. In some embodiments, the front door 200 is also formed similar to as described above with respect to the open box and then secured to the open box. Such construction is generally depicted in the accompanying FIGS. 13-15.

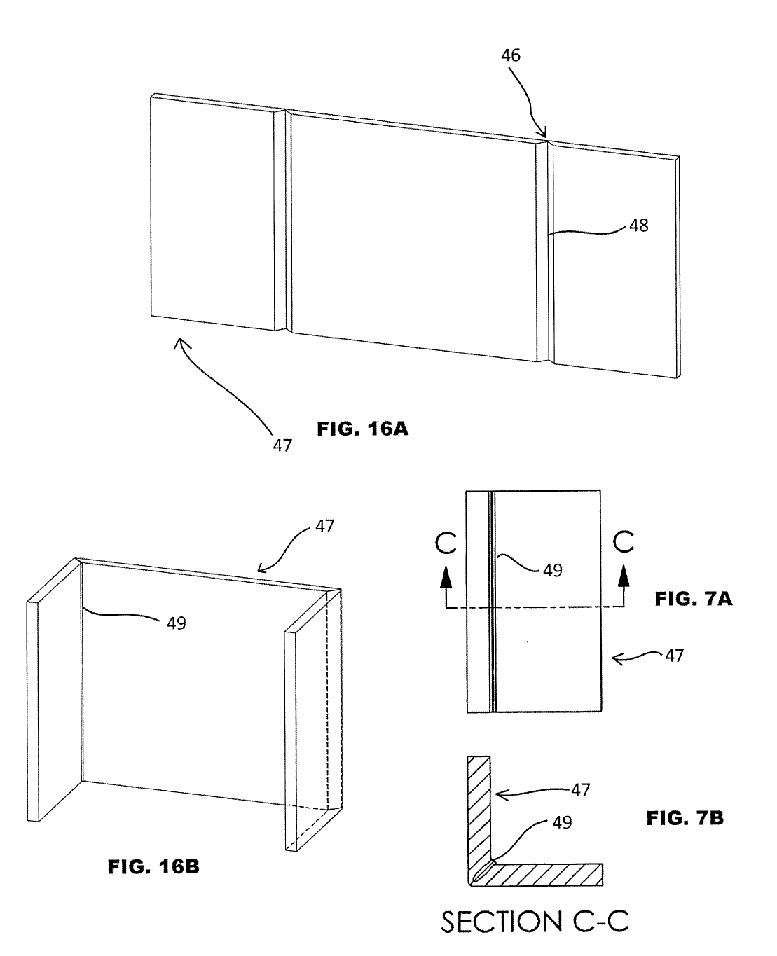

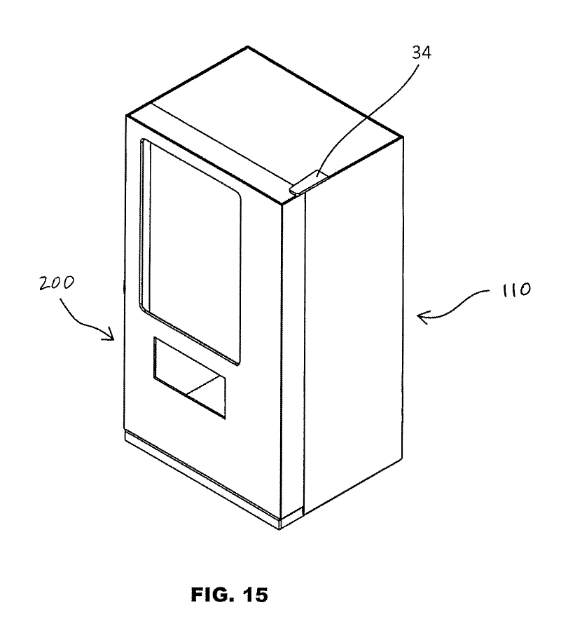

To achieve square or substantially square corners, or otherwise to achieve curves with tight radii, it is preferable in some embodiments of the present invention that a groove is cut into the polymer material along the desired bend line. Referring now to FIGS. 7A-7B and 16A-16B, forming the enclosure by bending the various sections of the polymer sheet is performed by first machining a V-groove 46 in the polymer sheet 47 along the intended bend line 48. A heated bending bar (not shown) is inserted into the V-groove to heat the polymer to a desired softness. The heated bending bar is then removed and the polymer sheet is bent along the V-grove so that the inner surfaces of the V-groove are bent together. When the polymer is heated appropriately, the two sides of the V-groove will, once joined, also weld together forming a weld joint 49 along the bend line 48. Like the hot gas welding method or the extrusion weld method used in joining two separate pieces of polymer material, heat bending the material by utilizing the groove and heat bar technique to join the polymer along the bend line creates a strong connection where the interior of the connection may exhibit evidence of a weld connection, but the exterior of the connection is seamless. In one embodiment, properly bending the material creates a U-shaped piece 103 that is welded to the top 2 and the bottom 1 using welding processes described above.

An alternate embodiment of the present invention is described with reference to FIGS. 18 and 19. Accordingly, the polymer cabinet utilizes first 104 and second 105 L-shaped pieces, each preferably formed by heat bending. The L-shape pieces 104, 105 are smaller and less cumbersome than the U-shaped piece 103. The two L-shaped pieces 104, 105 are welded to the bottom panel 1 and the top panel 2 so as to create an exterior cabinet 110 that defines an interior area 112. In one embodiment (not shown), the first L-shaped piece 104 is welded to the second L-shaped piece 105 along a joint between the two L-shaped pieces so as to create a continuous back panel 3. In another embodiment, a vertical piece 106 is welded to the rear of the cabinet along the joint between the two L-shaped pieces.

A method of construction that utilizes two L-shaped pieces 104, 105 provides benefits over a method of construction that utilizes a single U-shaped piece 103. For instance, the heated bend process for the L-shaped pieces 104, 105 is less complicated than the heated bend process for the U-shaped piece 103 because each L-shaped piece 104, 105 only requires one bend. Furthermore, each L-shaped piece 104, 105 is smaller and lighter than a U-shaped piece 103. Consequently, material handling is easier for the L-shaped pieces 104, 105 as opposed to the U-shaped piece 103. Additionally, embodiments that include a vertical piece 106 add additional strength to the exterior cabinet 110.

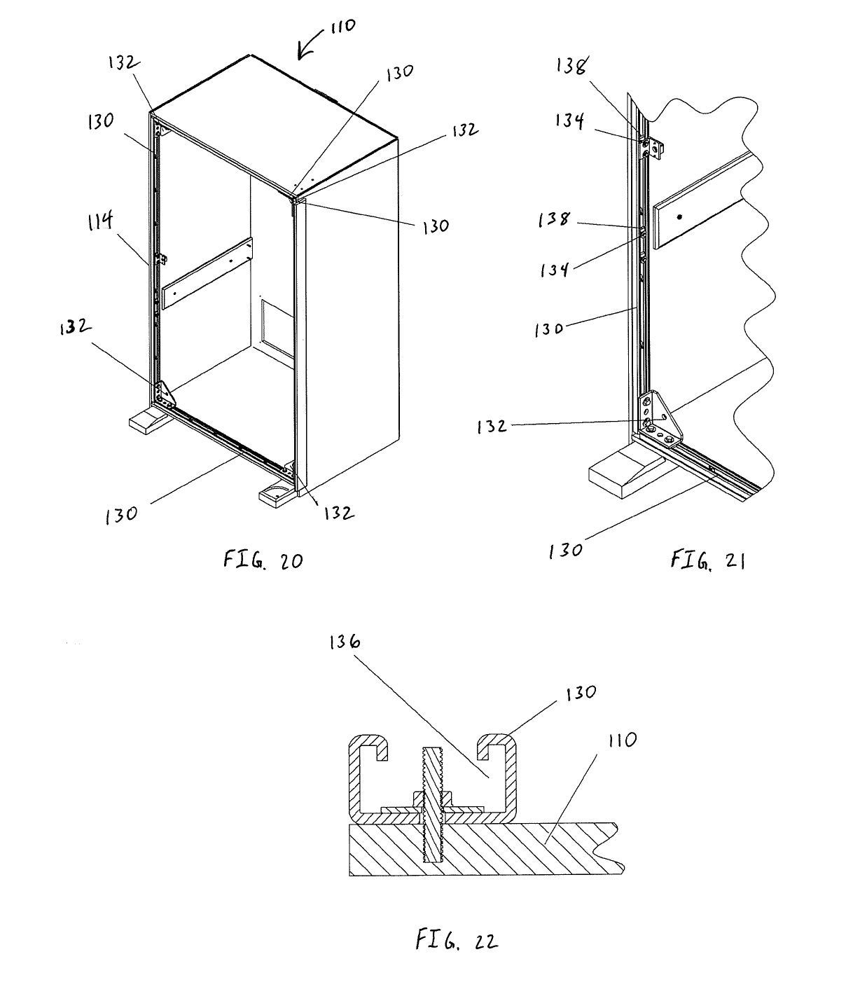

Various embodiments of the present invention include one or more additional features. For instance, one embodiment includes support legs 120 welded to the bottom of the exterior cabinet 110 to provide increased tip stability and to allow under-cabinet clearance 122 for material handling equipment such as fork trucks and pallet jacks. (FIG. 18). In another embodiment, at least one strut channel 130 is coupled to the exterior cabinet 110. (FIG. 20). In one embodiment, the at least one strut channel 130 is positioned near the front opening 114 of the exterior cabinet 110 so as to provide additional stiffness to the exterior cabinet 110. In another embodiment, a plurality of strut channels 130 are coupled to the exterior cabinet so as to completely frame the front opening 114 of the exterior cabinet 110. In one embodiment, each segment of strut channel 130 is structurally joined to an immediately adjacent strut channel 130 with at least one gusset 132 fastened at each corner of the front opening 114 of the exterior cabinet 110. The strut channel strengthens the cabinet walls, provides additional stiffness to resist cabinet flexing, and provides increased support for the cabinet door.

Aside from structural enhancements to the cabinet, the strut channels 130 provides fastening points 134 for components such as brackets and wire management clips, they and provide a cavity 136 that can be used for a wire and cable raceway. The fastening points are provided by channel nuts 138 which may be freely inserted into the open length of the strut channel 130. The channel nuts are movable, and therefore provide a flexible solution for mounting hole locations.

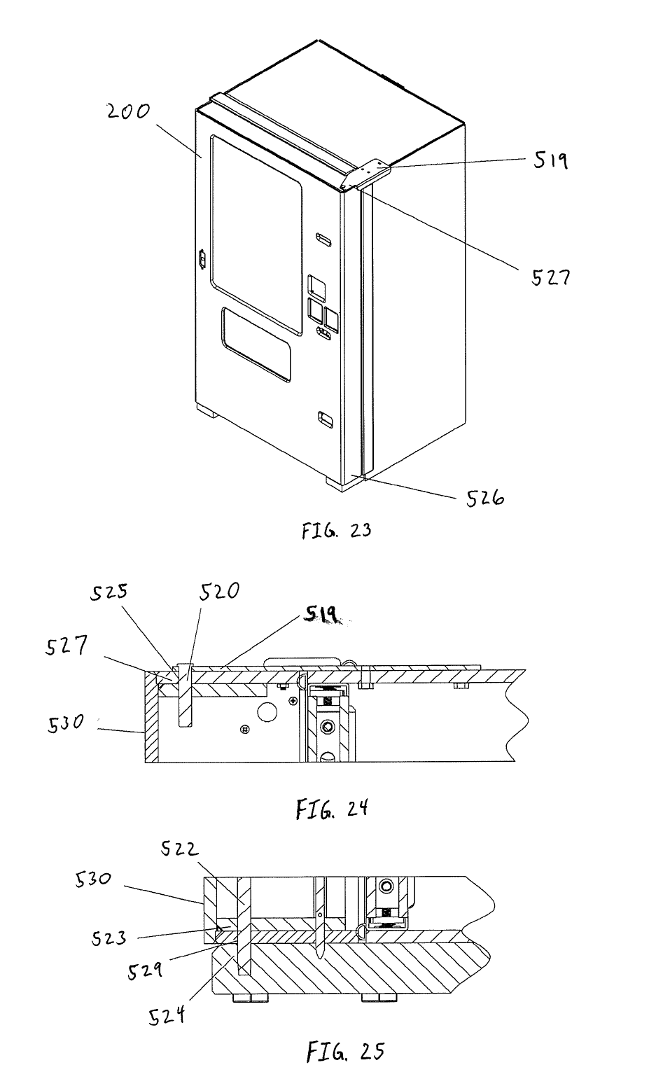

In various embodiments the door 200 will be connected to the exterior cabinet 110 by a number of different mechanisms. It is preferred in some embodiments that the connection utilizes a door hinge to enable the door to be repeatedly opened and closed. As shown in FIGS. 23-25, the polymer cabinet includes a door hinge bracket 519 attached to the cabinet top and rotationally coupled at 527 to the cabinet door 200 by hinge pin 520. A first end of the hinge pin is fixed to the hinge bracket and a second end of the hinge pin is inserted into a bore hole provided in the door such that the door rotates freely about the pin. A second hinge point 526 is provided at the bottom of the door by a second hinge pin 522 inserted into a bore hole in the bottom of the door at 523 and into the base of the cabinet at 524. Due to the thickness of the polymer utilized in the construction of the bottom of the cabinet, the hinge pin in some embodiments will be inserted into a bore hole in the bottom of the cabinet and a corresponding bore hole in the bottom of the door.

The thickness of the polymer material provides sufficient bearing surface at 525 and 529 for the pins to support the door 200 as it opens and closes. This is an advantage over a sheet metal cabinet, whose material thinness would require insertion of a bushing or bearing to provide sufficient support. Furthermore, the low coefficient of friction between the polymer and the hinge pins allows the door to rotate freely about the pins without the need for bushings or bearings. It should be appreciated that the forgoing attachment mechanism will be utilized in various embodiments to retrofit old metal vending machines having metal doors with the polymer doors described herein. In some embodiments attachment of the new doors will be accomplished by replacing the connection mechanism existing on old vending machines with the hinge described above. For old machines utilizing an attachment hinge having top and bottom hinge pins, the polymer door in some such embodiments will be attached through drilling bore holes corresponding to the existing hinge.

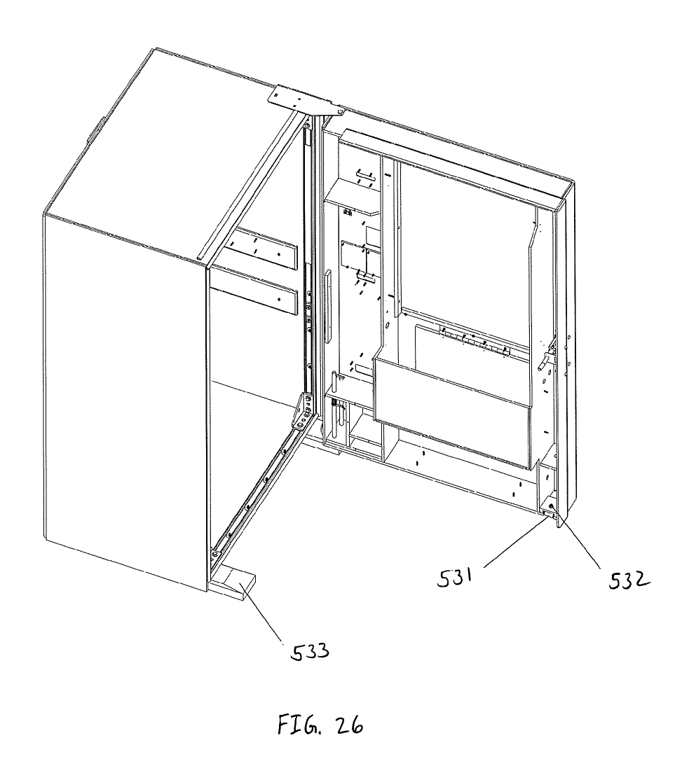

FIG. 26 depicts a cabinet door 200 having a roller 531 and a roller support 532 positioned at the bottom of the latch side 205 of the door 200. The roller 531 is positioned so as to ride upon a roller ramp 533 during opening and closing of the door. This roller and ramp system provides additional support to the door's weight during the opening and closing of the door 200, so as to reduce or prevent binding or sticking of the door. In one embodiment the roller ramp 533 is defined by a support leg 120. In another embodiment, the ramp 533 is formed directly into the bottom panel 1 of the exterior cabinet 110 without the need for additional components.

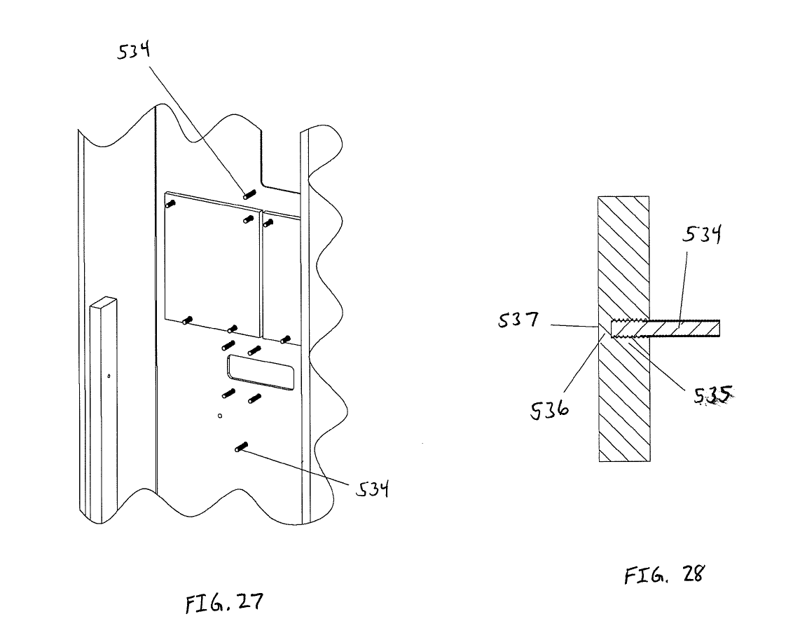

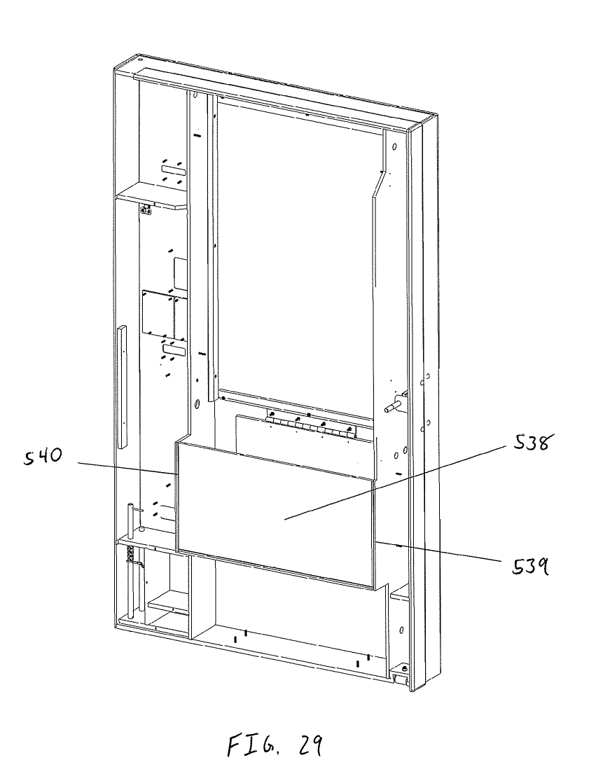

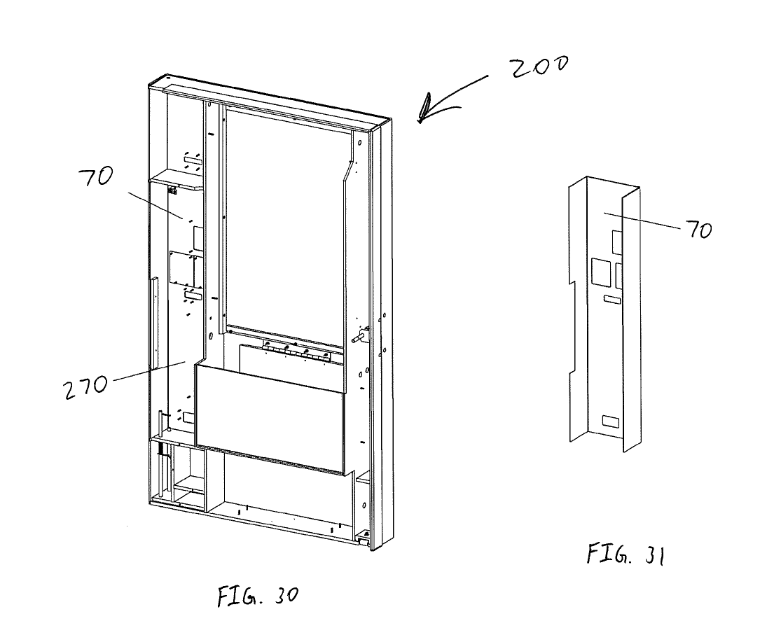

In a further embodiment, shown in FIGS. 27 and 28, the exterior cabinet 110 includes stud fasteners 534 as an alternative to screws. In some embodiments, attachment of the studs is accomplished by providing bore holes drilled to a predetermined depth. The studs are then screwed securely into the bore holes. Although an additional process step is required for installation of the studs into the polymer cabinet, the studs provide several advantages over the screws. The studs provide positive positioning when mounting components into the cabinet such that components are hung onto the stud while the securing fasteners are tightened. Conversely, screws require manually holding the component in position while the screw is installed. There is also the possibility of using an incorrect screw length in error when mounting a component into the cabinet. If a screw's length exceeds the thickness of the polymer material, the length of the screw will allow the screw to be driven completely through the wall thickness. Because the studs are installed to a preset insertion depth 535, there is no possibility of driving the stud through the material wall 536. Additionally, the polymer material thickness is sufficient enough to allow the studs to be threaded into the polymer material without breaching or deflecting the material surface opposite of the stud installation 537.

One embodiment of the cabinet includes a cabinet door having a product chute 538 which is structurally integrated into the door itself. (FIG. 29). The product chute width spans a substantial amount of the door's width, and it is welded to the vertical support structure of the door weldment at 539 and 540. In addition to allowing larger products to be delivered from the cabinet, the integrated chute increases the rigidity of the door structure.

Another embodiment of the invention is reinforced security column by means of a metal liner 70 installed within a door column 270 of the door 200. The purpose of the metal liner 70 is to provide increased security against theft for the area of the door containing the currency processing and storage devices. The metal liner 70 provides two general characteristics of deterrent. The first is increased resistance to material cutting devices such as drills and saws to inhibit access by breaching the door material, the second is increased resistance from attempts to mechanically pry the structural members open (through use of a pry bar, for example) due to the tendency of the metal liner to collapse in and over onto itself and cover the currency devices targeted for theft.

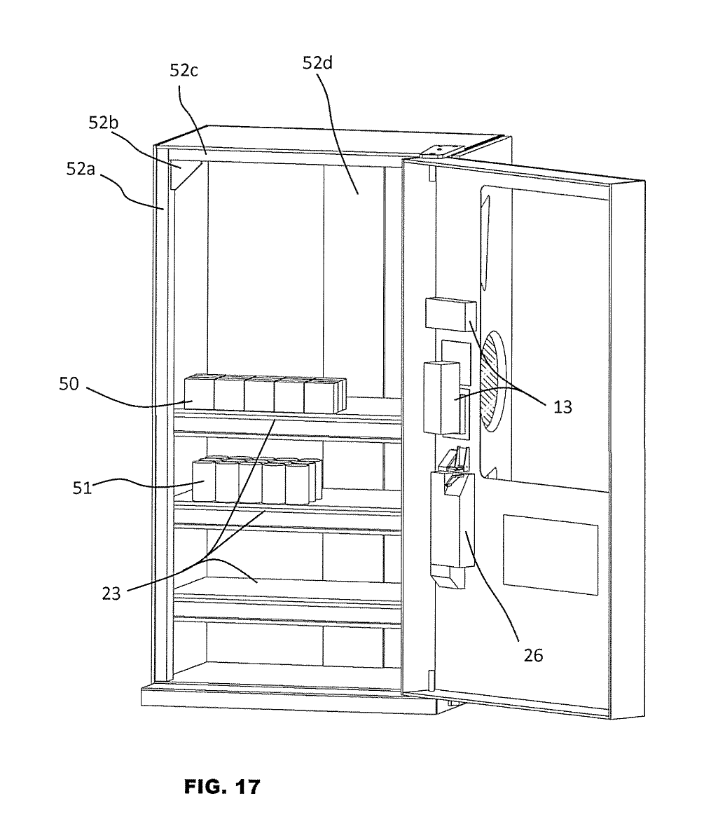

Once the basic shape of the enclosure has been achieved, the various components of the vending machine are added to the enclosure all as described above. Additionally, a front panel is added to complete the enclosure, and damaged sections are fixed also as described above. It should also be appreciated that, regardless of the method utilized to form the basic shape of the enclosure, additional polymer elements are capable of being efficiently added to the enclosure. For example, as shown in FIG. 17, shelving elements 23 in some embodiments are positioned within the interior area 112 of the exterior cabinet 110 so as to hold various components of the vending machine or to hold products 50, 51 to be vended. In certain embodiments, structural supports 52a, 52b, 52c, 52d are coupled to the enclosure 100 to add additional rigidity to the enclosure 100 or to support other components of the vending machine. Utilizing a polymer material to form the additional elements allows for the elements to be welded directly to the enclosure and one another in order to provide a structure having minimal visual seams and without the need of additional fasteners.

Although the present invention has been described in terms of the preferred embodiments, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

What is claimed is:

1. An enclosure comprising:
a cabinet;
a door; and
a securing mechanism operatively engaged with said cabinet and said door to secure said door to said cabinet,
wherein said cabinet comprises a panel having a geometric shape and walls connected to and extending from said panel and forming a cavity bounded by said panel and said walls,
wherein said cabinet further includes a power supply, a controller, and at least one support structure for supporting a product, and wherein at least one fastener fastens one or more of said power supply, controller or support structure to said panel or to one of said walls,
wherein said panel and said walls are comprised of a homopolymer or a copolymer material.

2. The enclosure as in claim 1 wherein said door is comprised of a homopolymer or a copolymer material.

3. The enclosure as in claim 2 wherein said door further comprises:
a door panel having a geometric shape and door walls connected to and extending from said first door panel and forming a door cavity bounded by said door panel and said door walls; and
a transaction segment and a user interface wherein at least a portion of each of said transaction segment and said user interface are secured within said door cavity by one or more fasteners,
wherein at least one of said fasteners is secured to at least said first door panel or at least one of said door walls.

4. The enclosure as in claim 1 wherein said securing mechanism comprises at least two pins wherein said pins engage said cabinet and said door such that said door is capable of swiveling about an axis formed between said pins.

5. The enclosure as in claim 1 wherein said panel includes a panel interior surface and a panel exterior surface, opposite said panel interior surface, and at least one wall includes a wall interior surface and a wall exterior surface, opposite said wall interior surface,
wherein said cavity is bounded in part by said panel interior surface and said wall interior surface,
wherein said panel interior surface and said wall interior surface are connected along a joint, and
wherein no joint exists between said panel exterior surface and said wall exterior surface.

6. The enclosure as in claim 5 wherein said joint is comprised of fused homopolymer or copolymer material of the panel and the wall.

7. The enclosure as in claim 1 further comprising at least one support segment, said support segment comprising a homopolymer or a copolymer material compatible with the homopolymer or copolymer material of said panel or said walls such that said support segment is welded to at least one of said walls or said panel.

8. The enclosure as in claim 7 wherein said panel, said walls, said support structure for supporting a product and said support segment are each comprised of polymer and wherein said support structure for supporting a product is welded to at least one of said walls, said panel or said support segment.

9. A vending machine door, the door comprising:
a panel having a geometric shape and walls, connected to and extending from said panel forming a cavity bounded by said panel and said side walls;
wherein the panel includes a panel interior surface and a panel exterior surface, opposite said panel interior surface, and
one or more openings passing through said panel from said panel interior surface to said panel exterior surface,
wherein said panel and said walls are at least partially formed from a homopolymer or copolymer material.

10. The door as in claim 9 further comprising:
a transaction segment and a user interface wherein at least a portion of each of said transaction segment and said user interface are secured within said cavity by one or more fasteners,
wherein at least one of said fasteners is secured to at least said panel or at least one of said side walls.

11. The door as in claim 9 further comprising:
a piece of transparent material,
wherein said piece of transparent material covers at least one of said one or more openings to form a viewing window.

12. The door as in claim 9 wherein the one or more openings includes a product dispensing hole.

13. The door as in claim 9 wherein said panel or said walls further include at least two pin holes, said pin holes forming an axis between them such that the panel and walls may rotate about said axis.

14. The door as in claim 9 wherein at least one wall includes a wall interior surface and a wall exterior surface, opposite said wall interior surface,
wherein said cavity is bounded in part by said panel interior surface and said wall interior surface,
wherein said panel interior surface and said wall interior surface are connected along a joint, and
wherein no joint exists between said exterior surface and said wall exterior surface.

15. The door as in claim 14 wherein said joint is comprised of fused homopolymer or copolymer material of the panel and the wall.

16. The door as in claim 9 wherein said homopolymer or copolymer material is polymer.

17. The door as in claim 9 wherein the geometric shape of said panel is substantially rectangular, said panel further including:
a first side, a second side, opposite said first side, a top and a bottom, opposite said top;
a first side wall extending from said first side, a second side wall extending from said second side, a top wall extending from said top and a bottom wall extending from said bottom wherein said first wall is connected to said first side, said top wall and said bottom wall and wherein said second wall is connected to said second side, said top wall and said bottom wall; and
wherein a design is carved into at least one of said walls or said panel.

18. A method for manufacturing a door for a vending machine, the method comprising:
selecting a first sheet, a second sheet and a third sheet of homopolymer or copolymer material;
carving two substantially parallel groves in said first sheet to form three sections, a middle section bounded by said grooves and two side sections each bounded by an edge of said first sheet and a groove in said first sheet;
heating the grooves in said first sheet at least until the material within the grooves in said first sheet melts;
bending each of the two side sections of said first sheet along said grooves to form a U-shape;
welding said second sheet to an edge of said middle section of said first sheet and to an edge of each of said side sections of said first sheet;
welding said third sheet to an edge of said middle section of said first sheet and to an edge of each of said side sections of said first sheet thereby forming a first cavity;
forming an opening through a thickness of said middle section of said first sheet panel; and
positioning a transparent material adjacent to said opening, so as to form a viewing window.

19. The method of claim 18, wherein said grooves are carved in a V-shaped groove.

20. The method of claim 18, wherein said grooves are heated with a heated bending bar.
